(19) United States
(12) Patent Application Publication
(10) Pub. No.: US 2015/0052216 A1
(43) Pub. Date: Feb. 19, 2015

(54) MANAGING DIGITAL CONTENT CONSUMPTION DATA

(71) Applicant: Red Hat, Inc., Raleigh, NC (US)

(72) Inventors: John Matthews, Wake Forest, NC (US); Wes Hayutin, Raleigh, NC (US); Christopher Duryee, Durham, NC (US); James Slagle, Raleigh, NC (US); Chris Morgan, Raleigh, NC (US); Todd Sanders, Clayton, NC (US)

(73) Assignee: Red Hat, Inc., Raleigh, NC (US)

(21) Appl. No.: 13/966,487

(22) Filed: Aug. 14, 2013

(51) Int. Cl. H04L 29/08

(52) U.S. Cl. CPC H04L 67/1097
USPC 709/216

(57) ABSTRACT

Systems and methods for managing data reflecting digital content consumption by computer systems. An example method may comprise: receiving a plurality of digital content consumption data objects, each digital content consumption data object comprising a timestamp and an identifier of a digital content item being consumed by the computer system at the moment of time defined by the timestamp; storing the plurality of digital content consumption data objects in a memory; receiving a request for digital content consumption information for a specified period of time; and retrieving from the memory two or more digital content consumption data objects having timestamps within the specified period of time.

### TECHNICAL FIELD

The present disclosure is generally related to distributed computer systems, and is more specifically related to systems and methods for managing data reflecting digital content consumption by computer systems.

### BACKGROUND

In distributed computer systems, such as cloud systems, service providers may supply a wide range of computing resources, including physical servers and/or virtual machines, raw and file-based storage, firewalls, load balancers, IP addresses, virtual local area networks (VLANs), wide area network (WAN) connectivity, and/or software products. The resources may be provisioned on-demand from large resource pools, with the ability to scale the services up and down in real time.

### BRIEF DESCRIPTION OF THE DRAWINGS

The present disclosure is illustrated by way of examples, and not by way of limitation, and may be more fully understood with references to the following detailed description when considered in connection with the figures, in which:

FIG. 1 depicts a high-level component diagram of one illustrative embodiment of a distributed computer system 100 in accordance with one or more aspects of the present disclosure;

FIG. 2 schematically depicts an example of the structure of a digital content consumption data object, in accordance with one or more aspects of the present disclosure;

FIG. 3 depicts a flow diagram of a method for managing data reflecting consumption of digital content by computer systems, in accordance with one or more aspects of the present disclosure; and

FIG. 4 depicts a block diagram of an illustrative computer system operating in accordance with examples of the present disclosure.

### DETAILED DESCRIPTION

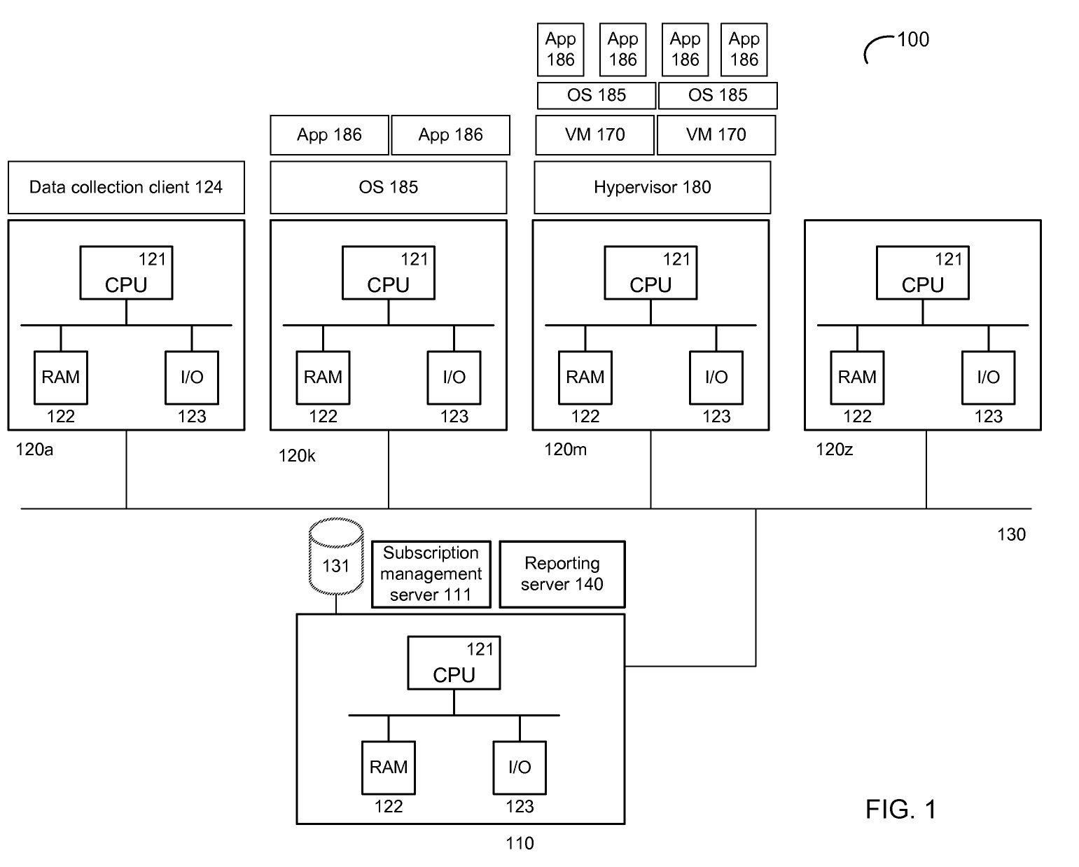

Described herein are methods and systems for managing data reflecting consumption of digital content by computer systems. “Computer system” herein shall refer to a system comprising one or more processors, one or more memory devices, and one or more input/output (I/O) interfaces. In certain implementations, a computer system may be provisioned by a cloud service provider and may comprise physical servers and/or virtual machines, raw and file-based storage, firewalls, load balancers, IP addresses, virtual local area networks (VLANs), wide area network (WAN) connectivity, and/or software products. In an illustrative example, a computer system may comprise one or more virtual machines executed on one or more physical servers interconnected by one or more networks, as schematically depicted in FIG. 1.

A computer system may consume digital content (e.g., software products) under a managed subscription model. A subscription establishes relationships between one or more digital content items and one or more computer systems which consume the digital content (e.g., by executing the software products), by specifying entitlements of the computer systems to consume the digital content. An entitlement may specify the number of servers and/or processors licensed to consume the specified digital content and the entitlement period of time (e.g., a time period over which the digital content is licensed to be consumed under the subscription, or the license expiration date). An entitlement may further specify other information related to the digital content, including, e.g., architectures that the digital content is available for, support levels for the digital content, content repositories on which the digital content may be accessed, etc.

A remote or on-premises subscription management server may manage subscriptions for one or more computer systems operated by an organizational entity (e.g., a customer account of a cloud-based system customer). The digital content may reside on one or more remote or on-premise content delivery servers. Either or both of the subscription management server and the content delivery server may be operated by the organizational entity itself or by a third party subscription service provider. In certain implementations, the digital content may comprise executable files, binary data, documents, media content files, and/or binary data streams. In an illustrative example, digital content may comprise one or more software products. The latter term refers to one or more software packages, including one or more primary software packages and optional associated packages containing software dependencies (e.g., drivers, middleware, etc.).

A subscription management server may, via a management user interface, be capable of presenting (e.g., displaying) information on the current state of digital content consumption by a managed computer systems. However, the current usage data is not sufficient to fully describe the entitlement usage by one or more computer systems (e.g., computer systems belonging to a cloud system customer).

The present disclosure addresses the above noted deficiency by collecting digital content consumption data over a period of time and presenting the collected consumption data, e.g., via a reporting user interface. In accordance with one or more aspects of the present disclosure, a digital content consumption data collection daemon may be executed by a computer system consuming digital content under a managed subscription model. “Daemon” herein shall refer to a computer program which is executed as a background process. In certain implementations, the parent process of the digital content consumption data collection daemon may be a process directly spawned by the operating system kernel (such as the system initialization process, e.g., init process). The digital content consumption data collection daemon may using a logfile, the system console, or the system null device (such as /dev/null) as the standard input, standard output and/or standard error device.

The digital content consumption data collection daemon may periodically collect digital content consumption data. A digital content consumption data object may comprise a timestamp and one or more identifiers of digital content items (e.g., process identifiers) being consumed by the managed computer system at the moment of time defined by the timestamp. A digital content consumption data object may further comprise values of one or more parameters describing the hardware of the computer system, such as the number of processors, the amount of memory, etc.

The collected information may be stored locally by the managed computer system or transmitted to an external computer system (e.g., a subscription management server or a dedicated reporting server), to be used by reporting and/or billing applications. In an illustrative example, a reporting server may, responsive to receiving a request via a user interface, generate a report based on a plurality of digital content consumption data objects covering a period of time specified by the request.

Various aspects of the above referenced methods and systems are described in details herein below by way of examples, rather than by way of limitation.

FIG. 1 depicts a high-level component diagram of an illustrative example of a subscription management system 100 in accordance with one or more aspects of the present disclosure. Subscription management system 100 may include a subscription management server 110 and a plurality of managed computer systems 120a-120z interconnected via one or more networks 130.

Each of computer systems 110 and 120a-120z may comprise one or more processors communicatively coupled to memory devices and input/output (I/O) devices. “Processor” or “CPU” herein refers to a device capable of executing instructions encoding arithmetic, logical, or I/O operations. In one illustrative example, a processor may follow Von Neumann architectural model and may include an arithmetic logic unit (ALU), a control unit, and a plurality of registers. In a further aspect, a processor may be a single core processor which is typically capable of executing one instruction at a time (or process a single pipeline of instructions), or a multi-core processor which may simultaneously execute multiple instructions. In another aspect, a processor may be implemented as a single integrated circuit, two or more integrated circuits, or may be a component of a multi-chip module (e.g., in which individual microprocessor dies are included in a single integrated circuit package and hence share a single socket). “Memory device” herein refers to a volatile or non-volatile memory device, such as RAM, ROM, EEPROM, or any other device capable of storing data. “I/O device” herein refers to a device capable of providing an interface between one or more processor pins and an external device capable of inputting and/or outputting binary data.

In an illustrative example, managed computer systems 120a-120z may be provisioned by a cloud service provider operating a subscription management server 110. The latter may execute a subscription management server process 111 to maintain an inventory of subscriptions available to managed computer systems 120a-120z, and a reporting server process 140 to provide digital content consumption reports. Managed computer systems 120a-120z may be operated by one or more customers of the cloud service provided by the cloud service provider. A cloud service customer may be represented, e.g., by an organizational entity associated, by the cloud service provider, with a customer account.

In an illustrative example, a managed computer system, such as computer system 120k, may execute an operating system 185 and one or more applications 186. In another illustrative example, a managed computer system, such as computer system 120m, may run one or more virtual machines 170, by executing a software layer 180, often referred to as “hypervisor,” above the hardware and below the virtual machines. In certain implementations, hypervisor 180 may be a component of operating system 185 executed by host computer system 120m. Alternatively, hypervisor 180 may be provided by an application running under host operating system 185, or may run directly on host computer system 100 without an operating system beneath it. Hypervisor 180 may abstract the physical layer, including processors, memory, and I/O devices, and present this abstraction to virtual machines 170 as virtual devices, including virtual processors 190, virtual memory 192, and virtual I/O devices 194. Virtual machine 170 may execute a guest operating system 185 which may utilize underlying virtual devices 190, 192, and 194, each of which may map to a device of the host machine (e.g., a network interface device, a CD-ROM drive, etc.). One or more applications 186 may be running on a virtual machine 170 under guest operating system 185. In certain implementations, computing resources and/or digital content, including virtual machines 170, operating systems 185 and/or applications 186, may be provisioned and consumed under a managed subscription model. Digital content consumed by managed computer systems 120a-120z may comprise executable files, binary data, documents, media content files, and/or binary data streams. In an illustrative example, digital content may comprise a software product. The latter term may refer to one or more software packages, including one or more primary software packages and optional associated packages containing software dependencies (e.g., drivers, middleware, etc.).

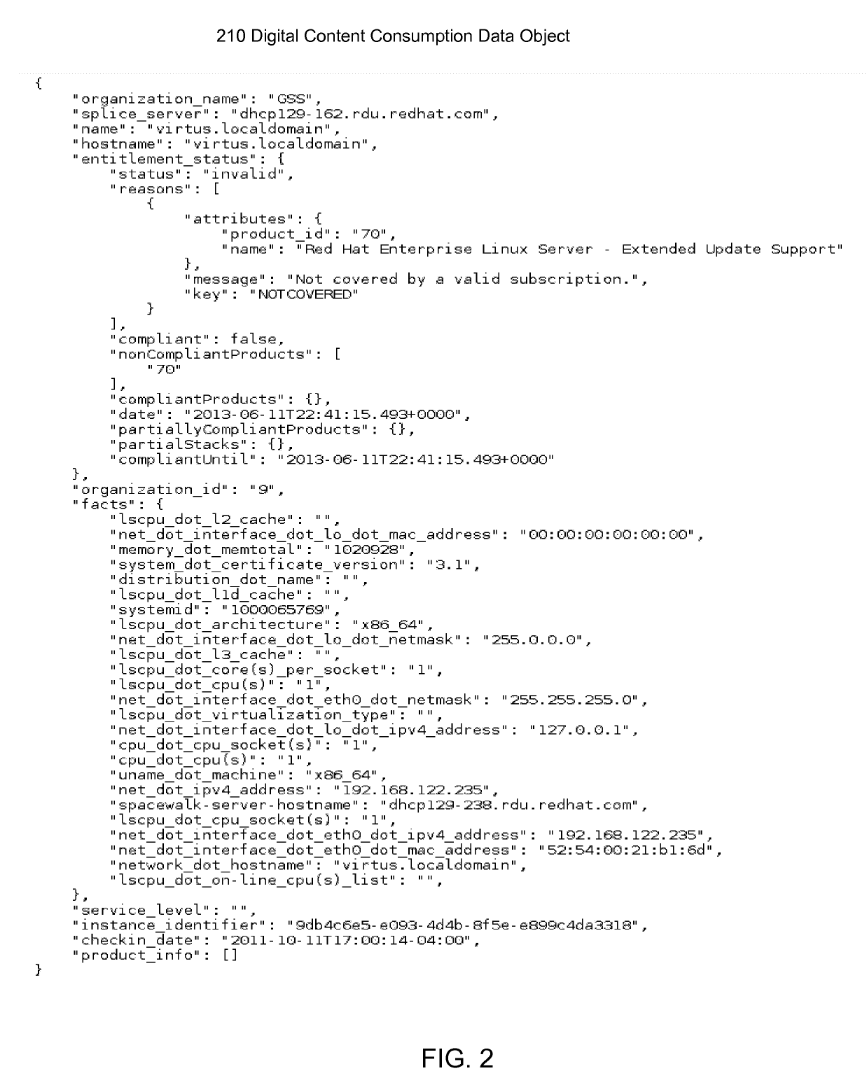

A managed computer system, such as computer system 120a, may execute a digital content consumption data collection client 124, which may periodically collect digital content consumption data. An example of the structure of a digital content consumption data object is schematically illustrated by FIG. 2. As schematically illustrated by FIG. 2, digital content consumption data object 210 may comprise a timestamp and one or more identifiers of digital content items (e.g., process identifiers) being consumed by the managed computer system.

In certain implementations, digital content consumption data object 210 may further comprise an identifier of the managed computer system by which the digital content consumption data object has been originated. Digital content consumption data object 210 may further comprise the current status of the entitlement to consume one or more digital content items identified by the corresponding fields of the digital content consumption data object.

In certain implementations, digital content consumption data object 210 may further comprise the values of one or more system parameters describing the managed computer system, such as MAC addresses of one or more network interfaces of the managed computer system, IP addresses of one or more network interfaces of the managed computer system, network hostname of the managed computer system etc. Digital content consumption data object 210 may further comprise the values of one or more parameters describing the hardware of the managed computer system, such as the architecture and the number of processors, the amount of memory, etc.

In an illustrative example, the digital content consumption data collection daemon may obtain one or more identifiers of running process and other process-related information from the output of an operating system command that returns the status of running processes in the computer system, such as, for example, ps command in Unix family of operating systems. The digital content consumption data collection daemon may then assign the identifiers of running processes and related parameters to one or more fields of a digital content consumption data object.

In an illustrative example, the digital content consumption data collection daemon may obtain values of one or more parameters describing the processors of the computer system from one or more system files, such as, for example, /proc/cpuinfo file in Linux operating system. In another illustrative example, the digital content consumption data collection daemon may obtain values of one or more parameters describing the memory of the computer system from one or more system files, such as, for example, /proc/meminfo file in Linux operating system. In another illustrative example, the digital content consumption data collection daemon may obtain values of one or more parameters describing the memory of the computer system from the output of an operating system command that returns the status, such as, for example, vmstat command in Unix family of operating systems. The digital content consumption data collection daemon may then assign the values of one or more hardware parameters to one or more fields of a digital content consumption data object.

The digital content consumption data collection daemon may store a plurality of digital content consumption data objects in a data store 131. The latter may reside locally on the managed computer system 120 or on an external computer system (e.g., a subscription management server 110 or a dedicated reporting server (not shown in FIG. 1)). In an illustrative example, the digital content consumption data may be stored in a relational database. In another illustrative example, the digital content consumption data may be stored in a hierarchical database. Alternatively, the digital content consumption data may be stored in one or more data files which may optionally be indexed, e.g., by the timestamp field.

The digital content consumption data may be retrieved by reporting and/or billing applications. Responsive to receiving a request via a user interface, reporting server 140 may retrieve from data store 131 a plurality of digital content consumption data objects covering a period of time specified by the request and generate a digital content consumption report.

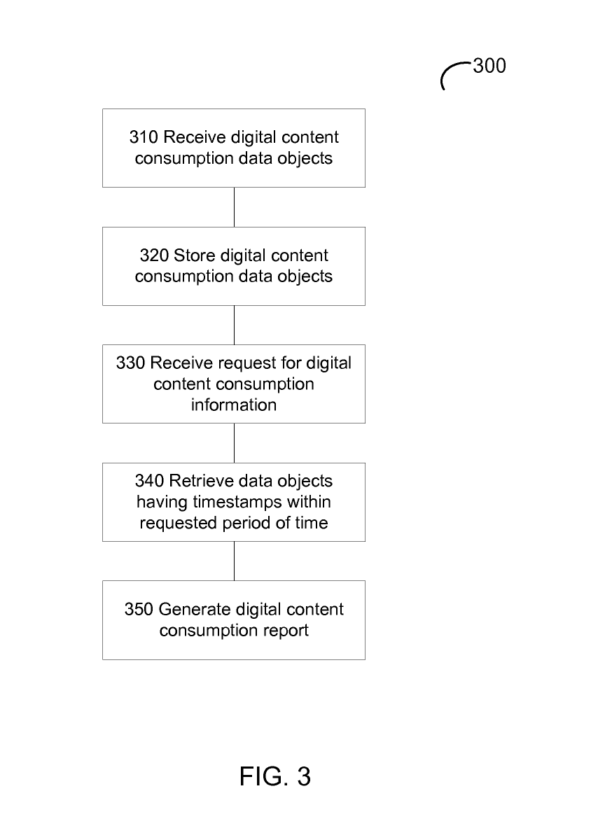

FIG. 3 depicts a flow diagram of one embodiment of a method 300 for managing data reflecting consumption of digital content by computer systems. Method 300 may be performed by a computer system that may comprise hardware (e.g., circuitry, dedicated logic, and/or programmable logic), software (e.g., instructions executable on a computer system to perform hardware simulation), or a combination thereof. In one illustrative example, method 300 may be performed by a reporting server 140. Method 300 and/or each of its individual functions, routines, subroutines, or operations may be performed by one or more physical processors of the computer system executing the method.

At block 310, a reporting server may receive from a managed computer system a plurality of digital content consumption data objects reflecting consumption of one or more digital content items by the managed computer system. As noted herein above, a digital content consumption data object may comprise a timestamp and one or more identifiers of digital content items (e.g., process identifiers) being consumed by the managed computer system. In certain implementations, a digital content consumption data object may further comprise values of one or more parameters describing the hardware of the computer system, such as the number of processors, the amount of memory, etc.

At block 320, the reporting server may store the plurality of digital content consumption data objects in a data store. As noted herein above, the digital content consumption data may be stored in a relational database. In another illustrative example, the digital content consumption data may be stored in a hierarchical database. Alternatively, the digital content consumption data may be stored in one or more data files which may optionally be indexed, e.g., by the timestamp field.

At block 330, the reporting server may receive a request for digital content consumption information. The request may specify a period of time that should be covered by the response. The request may further specify one or more digital content item identifiers for which a consumption report is requested.

At block 340, responsive to receiving the request, the reporting server may retrieve from the data store two or more digital content consumption data objects having timestamps within the specified period of time.

At block 350, the reporting server may generate a digital content consumption report based on the retrieved digital content consumption data objects. Upon completing the operations schematically described by block 350, the method may terminate.

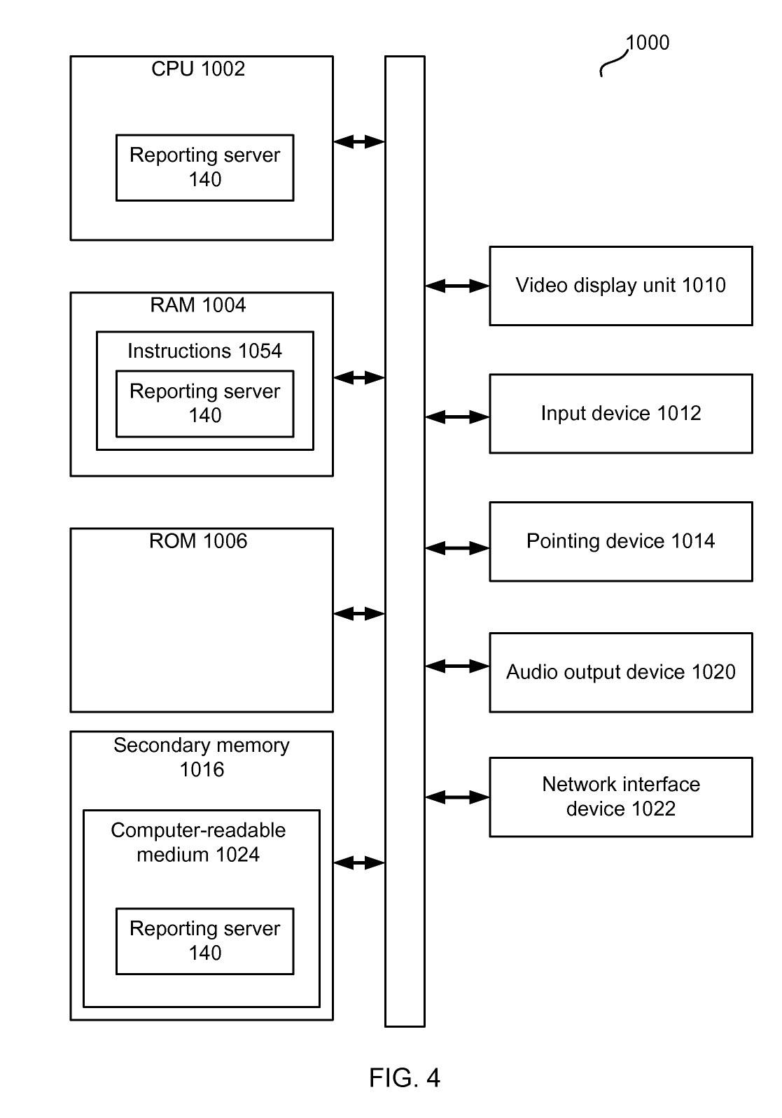

FIG. 4 depicts an example computer system 1000 within which a set of instructions, for causing the computer system to perform any one or more of the methods described herein, may be executed. In certain embodiments, computer system 1000 may correspond to computer system 110 of FIG. 1.

In certain embodiments, computer system 1000 may be connected (e.g., via a network, such as a Local Area Network (LAN), an intranet, an extranet, or the Internet) to other computer systems. Computer system 1000 may operate in the capacity of a server or a client computer in a client-server environment, or as a peer computer in a peer-to-peer or distributed network environment. Computer system 1000 may be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” may include any collection of computers that individually or jointly execute a set (or multiple sets) of instructions to perform any one or more of the methods described herein.

In a further aspect, computer system 1000 may include a physical processor 1002, a volatile memory 1004 (e.g., random access memory (RAM)), a non-volatile memory 1006 (e.g., read-only memory (ROM) or electrically-erasable programmable ROM (EEPROM)), and a secondary memory 1016 (e.g., a data storage device), which may communicate with each other via a bus 1008.

Processor 1002 may be provided by one or more physical processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 1000 may further include a network interface device 1022. Computer system 1000 also may include a video display unit 1010 (e.g., an LCD), an alphanumeric input device 1012 (e.g., a keyboard), a pointing device 1014 (e.g., a mouse), and an audio output device 1020 (e.g., a speaker).

Secondary memory 1016 may include a non-transitory computer-readable storage medium 1024 on which may be stored instructions of reporting server 140. Instructions of reporting server 140 may also reside, completely or partially, within main memory 1004 and/or within processor 1002 during execution thereof by computer system 1000, hence, main memory 1004 and processor 1002 may also constitute machine-readable storage media.

While computer-readable storage medium 1024 is shown in the illustrative embodiment as a single medium, the term “computer-readable storage medium” may include a single medium or multiple media (e.g., a centralized or distributed database, and/or associated caches and servers) that store the one or more sets of executable instructions. The term “computer-readable storage medium” may also include any non-transitory medium that is capable of storing or encoding a set of instructions for execution by a computer that cause the computer to perform any one or more of the methods described herein. The term “computer-readable storage medium” may include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and software components, or only in software.

Unless specifically stated otherwise, terms such as “updating”, “identifying”, “determining”, “sending”, “assigning”, or the like, refer to actions and processes performed or implemented by computer systems that manipulates and transforms data represented as physical (electronic) quantities within the computer system's registers and memories into other data similarly represented as physical quantities within the computer system memories or registers or other such information storage, transmission or display devices.

Embodiments described herein also relate to an apparatus for performing the methods described herein. This apparatus may be specially constructed for the required purposes, or it may comprise a general purpose computer system selectively programmed by a computer program stored in the computer system. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform functions, routines, subroutines, or operations of the methods described herein. The required structure for a variety of these systems will appear as set forth in the description above.

The above description is intended to be illustrative, and not restrictive. Although the present disclosure has been described with references to specific illustrative examples and embodiments, it will be recognized that the present disclosure is not limited to the embodiments described. The scope of the disclosure should be determined with reference to the following claims, along with the full scope of equivalents to which the claims are entitled.

1. A method, comprising:
receiving, by a processor, a plurality of digital content consumption data objects reflecting consumption by a computer system of digital content, each digital content consumption data object comprising a timestamp and an identifier of a digital content item being consumed by the computer system at a moment of time defined by the timestamp;
storing the plurality of digital content consumption data objects in a memory;
receiving a request for digital content consumption information for a specified period of time; and
retrieving from the memory a digital content consumption data object having a timestamp within the specified period of time.

2. The method of claim 1, further comprising generating a digital content consumption report in view of the digital content consumption data object.

3. The method of claim 1, wherein the computer system comprises one or more virtual machines executed by one or more physical servers.

4. The method of claim 1, wherein the digital content comprises at least one of:
an executable file, binary data, a document, a media content file, or a binary data stream.

5. The method of claim 1, wherein each object of the plurality of digital content consumption data objects comprises at least one of: a number of processors in the computer system or an amount of memory in the computer system.

6. The method of claim 1, wherein receiving the plurality of digital content consumption data objects comprises obtaining output of an operating system command returning a status of a process being executed by the computer system.

7. The method of claim 1, wherein receiving the plurality of digital content consumption data objects comprises retrieving a hardware parameter from a system file residing on the computer system.

8. The method of claim 1, wherein the computer system is provided by an external computer system communicatively coupled to the processor by a network.

9. A system comprising:
a memory; and
one or more processors, coupled to the memory, to:
receive a plurality of digital content consumption data objects reflecting consumption by a computer system of digital content, each digital content consumption data object comprising a timestamp and an identifier of a digital content item being consumed by the computer system at a moment of time defined by the timestamp;
store the plurality of digital content consumption data objects in a memory;
receive a request for digital content consumption information for a specified period of time; and
retrieve from the memory a digital content consumption data objects having a timestamp within the specified period of time.

10. The system of claim 9, wherein the processors are further configured to generate a digital content consumption report in view of the two or more digital content consumption data objects.

11. The system of claim 9, further comprising one or more virtual machines executed by one or more physical servers.

12. The system of claim 9, wherein the digital content comprises at least one of: an executable file, binary data, a document, a media content file, or a binary data stream.

13. The system of claim 9, wherein each object of the plurality of digital content consumption data objects comprises at least one of: a number of processors or an amount of memory.

14. The system of claim 9, wherein receiving the plurality of digital content consumption data objects comprises obtaining output of an operating system command returning a status of a process being executed by the computer system.

15. The system of claim 9, wherein receiving the plurality of digital content consumption data objects comprises retrieving a hardware parameter from a system file residing on the computer system.

16. A computer-readable non-transitory storage medium comprising executable instructions that, when executed by a processor, cause the processor to:
receive, by the processor, a plurality of digital content consumption data objects, each digital content consumption data object comprising a timestamp and an identifier of a digital content item being consumed by the computer system at a moment of time defined by the timestamp;
store the plurality of digital content consumption data objects in a memory;
receive a request for digital content consumption information for a specified period of time; and
retrieving from the memory a digital content consumption data object having a timestamp within the specified period of time.

17. The computer-readable non-transitory storage medium of claim 16, wherein the executable instructions further cause the computer system to generate a digital content consumption report in view of the two or more digital content consumption data objects.

18. The computer-readable non-transitory storage medium of claim 16, wherein the digital content comprises at least one of: an executable file, binary data, a document, a media content file, or a binary data stream.

19. The computer-readable non-transitory storage medium of claim 16, wherein each object of the plurality of digital content consumption data objects comprises at least one of:
a number of processors in the computer system or an amount of memory in the computer system.

20. The computer-readable non-transitory storage medium of claim 16, wherein receiving the plurality of digital content consumption data objects comprises obtaining output of an operating system command returning a status of a process being executed by the computer system.
